(19) United States
(12) Patent Application Publication
(10) Pub. No.: US 2026/0331385 A1
(43) Pub. Date: Oct. 22, 2026

(54) LAYERED MATERIAL, ELECTRODE ACTIVE MATERIAL FOR ELECTROCHEMICAL DEVICE, ELECTROCHEMICAL DEVICE, AND ELECTROCHEMICAL CAPACITOR

(71) Applicant: Panasonic Intellectual Property Management Co., Ltd., Osaka (JP)

(72) Inventors: Kosei OHURA, Osaka (JP); Tomoyasu YOKOYAMA, Osaka (JP)

(21) Appl. No.: 19/713,065

(22) Filed: Jun. 18, 2026

Related U.S. Application Data
(63) Continuation of application No. PCT/JP2024/034020, filed on Sep. 24, 2024.

(30) Foreign Application Priority Data
Dec. 27, 2023 (JP) 2023-220856

(51) Int. Cl. H01G 11/24; C01B 32/90; H01G 11/30; H01G 11/86

(52) U.S. Cl. CPC H01G 11/24; C01B 32/90; H01G 11/30; C01P 2002/72; C01P 2004/03; C01P 2006/40; H01G 11/86

(57) ABSTRACT

A layered material includes a layer. The layer includes a body and a terminal portion. The body has a composition represented by M1₍₁₋ₐ₎ₘM2ₐₘXₙ. In the composition, M1 and M2 are different from each other and each selected from the group consisting of Ti, Sc, Y, La, Zr, and Hf; X includes at least one selected from the group consisting of a carbon atom and a nitrogen atom; a is greater than 0 and less than 1; n is 1 or more and 4 or less; and m is greater than n and 5 or less. The terminal portion is present on a surface of the body.

This application is a continuation of PCT/JP2024/034020 filed on Sep. 24, 2024, which claims foreign priority of Japanese Patent Application No. 2023-220856 filed on Dec. 27, 2023, the entire contents of both of which are incorporated herein by reference.

### BACKGROUND OF THE INVENTION

### 1. Field of the Invention

The present disclosure relates to a layered material, an electrode active material for an electrochemical device, an electrochemical device, and an electrochemical capacitor.

### 2. Description of Related Art

In recent years, a material called MXene has attracted attention. MXene is a type of two-dimensional (2D) material, and, as described below, is a layered material having one layer or a plurality of layers. MXene generally has the form of particles of such a layered material, and the particles can be in powder, flake, or sheet form.

Studies are currently being conducted on the application of MXene to electrochemical capacitors. For example, according to the description in Michael Ghidiu et al., “Conductive two-dimensional titanium carbide ‘clay’ with high volumetric capacitance”, Nature volume 516, pages 78-81 (2014), when two-dimensional titanium carbide, which is a type of MXene, is produced by etching Al from Ti₃AlC₂, the use of a solution of lithium fluoride and hydrochloric acid increases the volumetric capacitance.

### SUMMARY OF THE INVENTION

The present disclosure provides a novel layered material that is advantageous for enhancing the performance of an electrochemical device.

The layered material of the present disclosure includes:
a layer, the layer including a body having a composition represented by M1₍₁₋ₐ₎ₘM2ₐₘXₙ and a terminal portion present on a surface of the body, wherein
in the composition,
M1 and M2 are different from each other and each selected from the group consisting of Ti, Sc, Y, La, Zr, and Hf,
X includes at least one selected from the group consisting of a carbon atom and
a nitrogen atom,
a is greater than 0 and less than 1,
n is 1 or more and 4 or less, and
m is greater than n and 5 or less.

According to the present disclosure, a novel layered material that is advantageous for enhancing the performance of an electrochemical device can be provided.

### BRIEF DESCRIPTION OF THE DRAWINGS

FIG. 1 is a diagram schematically showing an example of a layered material.

FIG. 2 is a diagram schematically showing an example of an electrochemical capacitor.

FIG. 3A is a graph showing the results of X-ray diffraction (XRD) measurements of precursors of layered materials according to Example 1, Example 2, Example 3, and Comparative Example 1.

FIG. 3B is a graph showing the results of XRD measurements of the layered materials according to Example 1, Example 2, Example 3, and Comparative Example 1.

FIG. 4 is a graph showing the results of XRD measurements of a precursor according to Reference Example 1, Ti₂SnC, and Zr₂SnC.

FIG. 5 is a graph showing the particle size distributions of the layered materials according to Example 1, Example 2, and Comparative Example 1.

FIG. 6A is a scanning electron microscope (SEM) photograph of the layered material according to Example 1.

FIG. 6B is an SEM photograph of the layered material according to Example 2.

FIG. 6C is an SEM photograph of the layered material according to Comparative Example 1.

### DETAILED DESCRIPTION

### Findings Underlying the Present Disclosure

As described in Michael Ghidiu et al., “Conductive two-dimensional titanium carbide ‘clay’ with high volumetric capacitance”, Nature volume 516, pages 78-81 (2014), MXene has been considered for use as an electrode active material in an electrochemical device such as an electrochemical capacitor. In such an electrochemical device, it is important that the specific capacitance, which is the capacitance per unit volume or per unit mass [F/cm³ or F/g] of the electrode active material, be high. In view of this, the present inventors have conducted intensive studies on MXene usable as an electrode active material in at least one of the negative electrode and the positive electrode of an electrochemical device. As a result, the present inventors have newly found that, by using a predetermined layered material as an electrode active material, an electrochemical device tends to have a high specific capacitance. Based on this new finding, the present inventors have completed the layered material of the present disclosure.

### Embodiments

Embodiments of the present disclosure are described below with reference to the drawings. The present disclosure is not limited to the following embodiments.

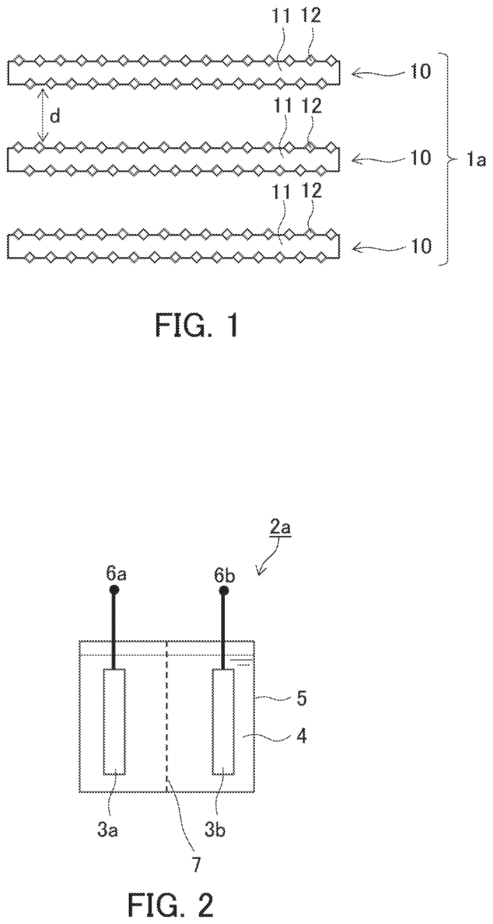

FIG. 1 schematically shows an example of the layered material of the present disclosure. As shown in FIG. 1, a layered material 1a includes a layer 10. The layer 10 includes a body 11 and a terminal portion 12. The body 11 has a composition represented by M1₍₁₋ₐ₎ₘM2ₐₘXₙ. In this composition, M1 and M2 are different from each other and each selected from the group consisting of Ti, Sc, Y, La, Zr, and Hf. X is at least one selected from the group consisting of a carbon atom and a nitrogen atom, a is greater than 0 and less than 1, n is 1 or more and 4 or less, and m is greater than n and 5 or less. The terminal portion 12 is an atom or atomic group present on the surface of the body 11. When an atom or functional group constituting the terminal portion 12 is represented by T, the layer 10 has a composition represented by M1₍₁₋ₐ₎ₘM2ₐₘXₙTₛ, where s is any number.

As described above, the body 11 in the layered material 1a has a composition represented by M1₍₁₋ₐ₎ₘM2ₐₘXₙ. Accordingly, for example, when the layered material 1a is used as an electrode active material in an electrochemical device, a higher specific capacitance tends to be exhibited than when a MXene containing only Ti as a transition metal is used as an electrode active material in an electrochemical device. The reason for this is not clear. M1 or M2 included in the above composition has a relatively large atomic radius. It is considered that this affects the arrangement of functional groups or atoms in the terminal portion 12 and tends to reduce the thickness of an electric double layer generated in the electrochemical device. Accordingly, it is considered that when the layered material 1a is used as an electrode active material in an electrochemical device, a high specific capacitance tends to be exhibited.

In the body 11, the arrangement of M1, M2, and X is not limited to a particular arrangement. For example, in the body 11, M1 and M2 are disposed at the vertices of a plurality of edge-sharing octahedra to form an octahedral array. In addition, X is disposed inside each octahedron.

M1 and M2 are not limited to particular atoms, provided that M1 and M2 are different from each other and each selected from the group consisting of Ti, Sc, Y, La, Zr, and Hf. Desirably, M1 and M2 are different from each other and each selected from the group consisting of Ti, Zr, and Hf. In this case, when the layered material 1a is used as an electrode active material in an electrochemical device, a high specific capacitance tends to be more readily exhibited.

In the above composition, more desirably, M1 is Ti, and M2 is Zr. In this case, when the layered material 1a is used as an electrode active material in an electrochemical device, a high specific capacitance tends to be more readily exhibited.

The above composition may be such that M1 is Ti or Zr, and M2 is Sc, Y, or La. In this case, when the layered material 1a is used as an electrode active material in an electrochemical device, a high specific capacitance tends to be more readily exhibited.

In the above composition, n and m are not limited to particular values, provided that n is 1 or more and 4 or less and m is greater than n and 5 or less. For example, n may be 1, 2, 3, or 4, or may be a value satisfying a requirement 1<n<2, 2<n<3, or 3<n<4. For example, when defects such as vacancies are present in the crystal constituting the body 11, n can be a non-integer. For example, m may satisfy a requirement m=n+1.

In the above composition, desirably, n is 2, and m is 3. In this case, when the layered material 1a is used as an electrode active material in an electrochemical device, a high specific capacitance tends to be more readily exhibited.

In the above composition, a may be any value greater than 0 and less than 1. Desirably, a is greater than 0 and 0.33 or less. In this case, when the layered material 1a is used as an electrode active material in an electrochemical device, a high specific capacitance tends to be more readily exhibited.

In the above composition, a may be greater than 0 and 0.2 or less.

In the above composition, a may be greater than 0 and 0.1 or less.

In the above composition, a may be greater than 0 and 0.67 or less, or greater than 0 and 0.5 or less.

The above composition may be such that M1 is Ti or Zr, and M2 is Hf, Sc, Y, or La. In this case, a may be greater than 0 and 0.67 or less. In this case, when the layered material 1a is used as an electrode active material in an electrochemical device, a high specific capacitance tends to be more readily exhibited. Further, in this case, a may be greater than 0 and 0.5 or less, or a may be greater than 0 and 0.33 or less. In the above composition, X may include a carbon atom. In this case, when the layered material 1a is used as an electrode active material in an electrochemical device, a high specific capacitance tends to be more readily exhibited. X may include only a carbon atom, may include only a nitrogen atom, or may include both a carbon atom and a nitrogen atom.

In the above composition, X may further include an oxygen atom. The content of oxygen atoms in X may be 20% to 80%, or 30% to 75%. Further, even when incorporation of an oxygen atom in X is not intended, an oxygen atom originating from a raw material can substitute for a carbon atom and be included in X. The content of oxygen atoms in X may be, on an atomic basis, less than 20%, 10% or less, 5% or less, 1% or less, or 0.1% or less. X may be free of oxygen atoms.

The terminal portion 12 may be any atom or atomic group that can be present on the surface of the body 11. The terminal portion 12 includes, for example, an atom having an electronegativity higher than the electronegativity of each of M1 and M2 included in the body 11. In this case, the terminal portion 12 is likely to be present in a desired state on the surface of the body 11. Examples of atoms having an electronegativity higher than the electronegativity of each of M1 and M2 include a hydrogen atom, an oxygen atom, a halogen atom, a chalcogen atom, a nitrogen atom, a phosphorus atom, a carbon atom, and an antimony atom. The electronegativity is the electronegativity based on Pauling's definition.

The terminal portion 12 may include, for example, at least one selected from the group consisting of a hydroxy group, a hydrogen atom, a halogen atom, a chalcogen atom, an amino group, a phosphorus atom, and an antimony atom. In this case, the terminal portion 12 is more likely to be present in a desired state on the surface of the body 11.

As shown in FIG. 1, the layered material 1a includes, for example, a plurality of the layers 10. In this case, the layered material 1a has, for example, a multilayer structure in which the layers 10 are stacked apart from each other. In this case, two adjacent layers 10 need not be completely apart from each other and may include portions in contact with each other. The layered material 1a may have a single-layer structure composed of only one layer 10. An aggregate of single-layer structures or multilayer structures, composed of the layered material 1a, may be in particulate form such as powder or flakes.

The thickness of the layer 10 is not limited to a particular value. The thickness of the layer 10 is, for example, 0.5 nm or more and 5 nm or less, and may be 0.5 nm or more and 3 nm or less. This thickness can vary depending on the number of layers containing M1 and M2 atoms.

The maximum dimension of the layer 10 in an in-plane direction perpendicular to the thickness direction of the layer 10 is not limited to a particular value. The maximum dimension is, for example, 0.1 μm or more and 200 μm or less, and may be 1 μm or more and 40 μm or less.

When the layered material 1a has a multilayer structure, a distance d between the layers 10 in the multilayer structure is not limited to a particular value. The distance d is, for example, 0.1 nm or more and 10 nm or less, and may be 0.1 nm or more and 5 nm or less, or about 1 nm.

When the layered material 1a has a multilayer structure, the maximum dimension of the layered material 1a in an in-plane direction perpendicular to the thickness direction of the layer 10 is not limited to a particular value. The maximum dimension is, for example, 0.1 μm or more and 100 μm or less, and may be 1 μm or more and 20 μm or less.

When the layered material 1a has a multilayer structure, a cation may be present between adjacent layers 10 in the thickness direction of the layer 10. Examples of the cation include a proton (H⁺), an alkali metal ion, an alkaline earth metal ion, and a quaternary ammonium ion. An anion or solvent may be present that is coordinated to the cation present between the layers 10. Examples of the anion or solvent coordinated to the cation include a halide ion, H₂O, and propylene carbonate.

When the layered material 1a has a multilayer structure, the number of layers 10 included in the layered material 1a is 2 or more, and may be 20 or more and 100,000 or less, or 1,000 or more and 20,000 or less. The thickness of the layered material 1a in the thickness direction of the layer 10 is not limited to a particular value. The thickness is, for example, 0.1 μm or more and 200 μm or less, and may be 1 μm or more and 40 μm or less.

When the layered material 1a has a multilayer structure, the number of layers 10 included in the layered material 1a may be 6 or less. In this case, the layered material 1a is referred to as a few-layer structure.

In an aggregate of the layered materials 1a, for example, most of the aggregate may be layered materials 1a having a single-layer structure and/or layered materials 1a being few-layer structures. For example, 50 vol % or more of the aggregate may be layered materials 1a having a single-layer structure and/or layered materials 1a being few-layer structures.

The above dimensions and distance may be calculated, for example, as number averages based on micrographs obtained by a scanning electron microscope (SEM), a transmission electron microscope (TEM), an atomic force microscope (AFM), or the like. In this case, for example, the above dimensions and distance can be calculated as number averages of 40 or more pieces of data. Alternatively, the above dimensions and distance may be calculated as distances in real space calculated based on the position of the (002) plane in reciprocal space in X-ray diffraction (XRD) measurement.

The method of producing the layered material 1a is not limited to a particular method. The layered material 1a can be synthesized, for example, by selective etching of A atoms from a precursor having a composition represented by MₘAXₙ. In the composition of the precursor, M collectively denotes metal atoms corresponding to M1 and M2 in the body 11 of the layered material 1a, and m and n respectively correspond to m and n in the body 11. A is an element of Group 12, Group 13, Group 14, Group 15, or Group 16, and A may be at least one element selected from the group consisting of Al, Zn, Ga, In, Tl, Si, Ge, Sn, Pb, P, As, S, and Cd. Desirably, A is Al. This precursor is called MAX and has a crystal structure in which one layer composed of A atoms is disposed between two layers represented by MₘXₙ. In each layer of MₘXₙ, M is disposed at the vertices of a plurality of edge-sharing octahedra to form an octahedral array. In addition, X is disposed inside each octahedron. In other words, each layer of MₘXₙ has a crystal lattice in which M is disposed to form each octahedron and X is disposed inside the octahedron. The structure of MAX is not limited to a particular structure. For example, when m=n+1 is satisfied, MAX has a repeating unit in which one X-atom layer is disposed between each pair of adjacent M-atom layers among (n+1) M-atom layers, and an A-atom layer is disposed adjacent to the (n+1)-th M-atom layer. In MAX, the A-atom layer is removed by selective etching of A atoms. The surface of the layer of MₘXₙ thus exposed is modified by an atom or atomic group derived from the etching solution. Thus, the terminal portion 12 is formed.

The etching solution used for selective etching of A atoms includes, for example, fluoride ions F⁻. The etching solution may be a liquid mixture of lithium fluoride and hydrochloric acid, or hydrofluoric acid. The selective etching of A atoms may be performed using a molten salt of a Lewis acid such as CuCl₂, using HCl at high temperature and high pressure, using a halogen gas such as Br₂ or I₂, or using an organic solution in which a halogen such as Br₂ or I₂ is dissolved.

The layered material 1a may be produced from a precursor other than MAX. For example, the layered material 1a may be produced by selective etching of A atoms from a precursor in which two or more A-atom layers are disposed between two layers of MₘXₙ.

After A atoms are selectively etched from a precursor such as MAX, a treatment such as ultrasonic treatment, manual shaking, or shaking using an automatic shaker may be performed. These treatments can promote separation, i.e., delamination, between the layers 10 in the layered material 1a. Thus, for example, the layered material 1a having a single-layer structure or being a few-layer structure is obtained. For example, manual shaking or shaking using an automatic shaker can apply, between the layers 10, a shear stress desired for delamination between the layers 10. For example, assume that the layered material 1a has a single-layer structure or is a few-layer structure. In this case, the ratio of the dimension of the layered material 1a in the thickness direction of the layer 10 to the dimension of the layered material 1a in an in-plane direction of the layer 10 is small. Even in such a case, manual shaking or shaking using an automatic shaker applies, between the layers 10, a shear stress desired for delamination between the layers 10, so that the layered material 1a is less likely to be fragmented and is more likely to be maintained at a desired size.

In the layered material 1a, a portion of A atoms derived from a precursor such as MAX may remain. The amount of A atoms remaining in the layered material 1a is, for example, 10 mass % or less, desirably 8 mass % or less, and more desirably 6 mass % or less, relative to the content of A atoms in the precursor. The amount of A atoms remaining in the layered material 1a may be, depending on the use of the layered material 1a, greater than 10 mass % relative to the content of A atoms in the precursor.

The layered material 1a may be produced by a method other than the method of selectively etching A atoms from a precursor such as MAX. For example, the layered material 1a may be produced by heat-treating metal M1, metal M2, graphite, and a halide of either M1 or M2 inside a sealed tube. The sealed tube is, for example, a quartz tube. The layered material 1a may be produced from metal M1, metal M2, a halide of either M1 or M2, and either CH₄ or N₂ by chemical vapor deposition (CVD).

For example, an electrode active material for an electrochemical device, the electrode active material including the layered material 1a, can be provided. As described above, when such an electrode active material is used in an electrochemical device, the electrochemical device tends to exhibit a high specific capacitance.

An electrode including the layered material 1a as an electrode active material can be provided. In this case, the surface of the electrode may be composed substantially only of the layered material 1a, or a binder may be present between the layered materials 1a on the surface of the electrode. The binder includes, for example, a resin and includes at least one selected from the group consisting of polytetrafluoroethylene, polyvinylidene fluoride, and styrene-butadiene rubber. The electrode including the layered material 1a as an electrode active material can be produced by shaping, into a film or sheet, an aggregate of the layered materials 1a or a mixture including an aggregate of the layered materials 1a and a binder. For example, a method including suction filtration can be applied to production of the electrode. Alternatively, the electrode may be produced using a coating method such as spray coating, bar coating, or dip coating.

The above electrode may be produced using a precursor of the layered material 1a or a modified form of the layered material 1a. For example, the surface of each particle of a polymer such as polystyrene is coated with the layered material 1a in a solvent to obtain coated particles. Next, the solvent is removed, and an aggregate of the coated particles is shaped into a film. Next, while the polymer is removed by high-temperature treatment or the like, hollow particles in which the layered material 1a remains as a shell are formed. The electrode may be produced in this manner. In this case, an electrochemical device using this electrode tends to have a higher specific capacitance and tends to have a higher coulombic efficiency.

The density of the above electrode is not limited to a particular value. The density is, for example, 1.5 g/cm³ or more, 2.0 g/cm³ or more, or 2.5 g/cm³ or more, and is desirably 3.0 g/cm³ or more. The density is more desirably 3.5 g/cm³ or more, still more desirably 4.0 g/cm³ or more, and particularly desirably 4.5 g/cm³ or more. The density is, for example, 10 g/cm³ or less.

The thickness of the above electrode is not limited to a particular value. The thickness is, for example, 3 μm or more, or 5 μm or more. The thickness may be 500 μm or less.

An electrochemical device includes, for example, a pair of electrodes and an electrode active material disposed in contact with at least one of the pair of electrodes. This electrode active material can include the layered material 1a.

FIG. 2 is a diagram schematically showing an example of an electrochemical capacitor. As shown in FIG. 2, an electrochemical capacitor 2a includes a positive electrode 3a and a negative electrode 3b. In the electrochemical capacitor 2a, the positive electrode 3a and the negative electrode 3b are disposed apart from each other in an electrolyte solution 4. At least one selected from the group consisting of the positive electrode 3a and the negative electrode 3b includes the layered material 1a as an electrode active material. According to such a configuration, the electrochemical capacitor 2a tends to exhibit a high specific capacitance.

The energy density stored in an electrochemical capacitor is generally calculated as (½)×CV², where C is the specific capacitance [F/cm³ or F/g], and V is the operating potential range [V]. The unit of energy density can be FV²/cm³ or FV²/g. On the other hand, the energy density stored in an electrochemical capacitor can be generally expressed in units of Wh/L or Wh/kg through conversion.

Assume that a measured value C₃ₚ [F/cm³ or F/g] of the specific capacitance of either the positive electrode or the negative electrode of an electrochemical capacitor has been obtained by a three-electrode half-cell measurement. In this case, a specific capacitance Cf [F/cm³ or F/g] of a full cell configured with the electrode used as both the positive electrode and the negative electrode can be estimated to be equal to (¼)C₃ₚ.

The electrolyte solution 4 is not limited to a particular electrolyte solution. The electrolyte solution 4 is, for example, a nonaqueous electrolyte solution. In this case, the operating potential range of the electrochemical capacitor 2a tends to increase. A wide operating potential range is advantageous for increasing the energy density that can be stored in the electrochemical capacitor 2a. The electrolyte solution 4 may be an aqueous electrolyte solution. In this case, the operating potential range can be adjusted to 1.2 V or less in order to prevent electrolysis of water. In addition, the operating temperature range of the electrochemical capacitor 2a can be adjusted to a temperature range in which water as a solvent is stably present in liquid form and freezing and vaporization of the water can be prevented (e.g., −40 °C to 80 °C). On the other hand, when the electrolyte solution 4 is a nonaqueous electrolyte solution, there are fewer restrictions on the operating potential range and the operating temperature range of the electrochemical capacitor 2a than when the electrolyte solution 4 is an aqueous electrolyte solution.

As shown in FIG. 2, in the electrochemical capacitor 2a, the electrolyte solution 4 is contained in a cell 5, and the interior of the cell 5 is partitioned by a separator 7 into a space in which the positive electrode 3a is disposed and a space in which the negative electrode 3b is disposed. The positive electrode 3a and the negative electrode 3b are electrically connected to a terminal 6a and a terminal 6b, respectively, disposed outside the cell 5.

The separator 7 may be any separator that does not hinder movement of electrolyte ions contained in the electrolyte solution 4. The separator 7 is, for example, a dielectric membrane. Examples of the dielectric membrane include porous membranes of polyolefins such as polypropylene and polytetrafluoroethylene. The separator 7 may include glass fibers.

The material of the cell 5 is not limited to a particular material. The material of the cell 5 may be a metal material such as stainless steel, a resin material such as polytetrafluoroethylene, or another material. The cell 5 may be sealed or open. Inside the cell 5, a void may be present or no void may be present.

The positive electrode 3a and the negative electrode 3b may be disposed in the cell 5, for example, such that the separator 7 is disposed between the positive electrode 3a and the negative electrode 3b and a stack including the positive electrode 3a, the separator 7, and the negative electrode 3b is wound.

As described above, at least one selected from the group consisting of the positive electrode 3a and the negative electrode 3b includes the layered material 1a as an electrode active material. The electrode active material, for example, exchanges electrons with electrolyte ions contained in the electrolyte solution 4.

For example, only the positive electrode 3a may include the layered material 1a as an electrode active material. In this case, the negative electrode 3b can include, as an electrode active material, a carbon material such as activated carbon, carbon nanotubes, or graphene, or Li₄Ti₅O₁₂ or the like. Only the negative electrode 3b may include the layered material 1a as an electrode active material. In this case, the positive electrode 3a can include, as an electrode active material, graphite, activated carbon, carbon nanotubes, or the like. When only one of the positive electrode 3a and the negative electrode 3b includes the layered material 1a as an electrode active material, the other electrode not including the layered material 1a may be composed substantially only of an electrode active material, or may be configured such that a binder is present between electrode active material particles. The binder includes, for example, a resin. The binder includes, for example, at least one selected from the group consisting of polytetrafluoroethylene, polyvinylidene fluoride, and styrene-butadiene rubber. Both the positive electrode 3a and the negative electrode 3b may include the layered material 1a as an electrode active material.

Each of the positive electrode 3a and the negative electrode 3b may be configured as a free-standing film, or may have a configuration in which a film and/or membrane including an electrode active material is formed on a current collector (not shown). The current collector may be any conductive current collector. The current collector includes, for example, a material such as stainless steel, aluminum, or an aluminum alloy.

The electrolyte solution 4 includes, for example, an electrolyte and a nonaqueous solvent. The electrolyte solution 4 may include an electrolyte and an aqueous solvent, or may be an ionic liquid. The electrolyte is dissolved in the nonaqueous solvent or the aqueous solvent and is present as a cation or an anion.

The electrolyte solution 4 includes, as an electrolyte, for example, at least one cation selected from the following group of cations and at least one anion selected from the following group of anions.

### <Group of Cations>

sodium ion (Na⁺)
magnesium ion (Mg²⁺)
1-ethyl-3-methylimidazolium ion (EMI⁺)
tributylmethylammonium ion (TrBMAm⁺)
tetrabutylammonium ion (TeBAm⁺)
tributylethylphosphonium ion (TrBEPh⁺)
tributylmethylphosphonium ion (TrBMPh⁺)
1-butyl-1-methylpyrrolidinium ion (1B1MPy⁺)
1-methyl-1-propylpyrrolidinium ion (1M1PPy⁺)
tetraethylammonium ion (Et4N⁺)
lithium ion (Li⁺)
proton (H⁺)

### <Group of Anions>

diethyl phosphate ion (DEPh⁻)
bis(fluorosulfonyl)imide ion (FSI⁻)
perchlorate ion (ClO₃O⁻)
bis(trifluoromethanesulfonyl)imide ion (TFSI⁻)
trifluoromethanesulfonate ion (Triflate⁻)
hexafluorophosphate ion (PF₆⁻)
tetrafluoroborate ion (BF₄⁻)
sulfate ion (SO₄²⁻)
chloride ion (Cl⁻)
iodide ion (I⁻)

The nonaqueous solvent that can be included in the electrolyte solution 4 is not limited to a particular nonaqueous solvent. The electrolyte solution 4 may include, for example, at least one selected from the following group of solvents. The nonaqueous solvent may include only one solvent or may be a mixture of a plurality of solvents.

### <Group of Solvents>

propylene carbonate (PC)
gamma-butyrolactone (gBL)
ethylene carbonate (EC)
ethyl methyl carbonate (EMC)
dimethoxyethane (DME)
dimethyl carbonate (DMC)
diethyl carbonate (DEC)
acetonitrile (AN)

The electrolyte solution 4 may further include, as necessary, a predetermined additive in addition to the solvent and the electrolyte.

When the terminals 6a and 6b of the electrochemical capacitor 2a are connected to a load, the electrochemical capacitor 2a is discharged. On the other hand, when the terminals 6a and 6b of the electrochemical capacitor 2a are connected to a power source, the electrochemical capacitor 2a is charged.

Depending on the combination of the electrode active material and the electrolyte solution 4, the electrochemical capacitor 2a may be configured as a pseudocapacitor or hybrid capacitor involving a Faradaic reaction.

### Supplementary Description

From the above description, the following techniques are disclosed.

### (Technique 1)

A layered material including:
a layer, the layer including a body having a composition represented by M1₍₁₋ₐ₎ₘM2ₐₘXₙ and a terminal portion present on a surface of the body, wherein
in the composition,
M1 and M2 are different from each other and each selected from the group consisting of Ti, Sc, Y, La, Zr, and Hf,
X includes at least one selected from the group consisting of a carbon atom and a nitrogen atom,
a is greater than 0 and less than 1,
n is 1 or more and 4 or less, and
m is greater than n and 5 or less.

### (Technique 2)

The layered material according to Technique 1, wherein
the terminal portion includes an atom having an electronegativity higher than an electronegativity of each of M1 and M2.

### (Technique 3)

The layered material according to Technique 1 or 2, wherein
the terminal portion includes at least one selected from the group consisting of a hydroxy group, a hydrogen atom, a halogen atom, a chalcogen atom, an amino group, a phosphorus atom, and an antimony atom.

### (Technique 4)

The layered material according to any one of Techniques 1 to 3, wherein
n is 2, and m is 3.

### (Technique 5)

The layered material according to any one of Techniques 1 to 4, wherein
X includes a carbon atom.

### (Technique 6)

The layered material according to any one of Techniques 1 to 5, wherein
M1 and M2 are atoms different from each other and each selected from the group consisting of Ti, Zr, and Hf.

### (Technique 7)

The layered material according to any one of Techniques 1 to 6, wherein
M1 is Ti, and M2 is Zr.

### (Technique 8)

The layered material according to Technique 7, wherein
a is greater than 0 and 0.33 or less.

### (Technique 9)

The layered material according to Technique 7, wherein
a is greater than 0 and 0.2 or less.

### (Technique 10)

The layered material according to Technique 7, wherein
a is greater than 0 and 0.1 or less.

### (Technique 11)

The layered material according to any one of Techniques 1 to 5, wherein
M1 is Ti or Zr, and
M2 is Sc, Y, or La.

### (Technique 12)

The layered material according to any one of Techniques 1 to 5, wherein
M1 is Ti or Zr,
M2 is Hf, Sc, Y, or La, and
a is greater than 0 and 0.67 or less.

### (Technique 13)

The layered material according to Technique 12, wherein
a is greater than 0 and 0.5 or less.

### (Technique 14)

The layered material according to Technique 12, wherein
a is greater than 0 and 0.33 or less.

### (Technique 15)

An electrode active material for an electrochemical device, including the layered material according to any one of Techniques 1 to 14.

### (Technique 16)

An electrochemical device including:
a pair of electrodes; and
an electrode active material disposed in contact with at least one of the pair of electrodes, wherein
the electrode active material includes the layered material according to any one of Techniques 1 to 14.

### (Technique 17)

An electrochemical capacitor including:
a positive electrode; and
a negative electrode, wherein
the positive electrode and the negative electrode are disposed apart from each other in an electrolyte solution, and
at least one selected from the group consisting of the positive electrode and the negative electrode includes the layered material according to any one of Techniques 1 to 14 as an electrode active material.

### (Technique 18)

The electrochemical capacitor according to Technique 17, wherein the negative electrode includes the layered material as an electrode active material.

### EXAMPLES

The present disclosure is described in more detail below by way of examples. The following examples are illustrative, and the present disclosure is not limited to the following examples.

### Example 1

TiC powder, ZrC powder, Ti powder, and Al powder were mixed in a zirconia mortar to obtain a powder mixture according to Example 1. These powders were provided by Kojundo Chemical Laboratory Co., Ltd. In the powder mixture according to Example 1, the molar ratio of TiC:ZrC:Ti:Al was 1.7:0.3:1:1. The powder mixture according to Example 1 was fired at 1,500 °C for 1 hour in an argon gas atmosphere to obtain a fired body (block) according to Example 1. The fired body according to Example 1 was pulverized in a zirconia mortar. Thus, a powder of a precursor according to Example 1 having a composition represented by Ti_{2.7}Zr_{0.3}AlC₂ was obtained.

The powder of the precursor according to Example 1, CuCl₂ powder, and NaCl powder were mixed in a zirconia mortar to obtain a powder mixture. In this powder mixture, the molar ratio of Ti_{2.7}Zr_{0.3}AlC₂:CuCl₂:NaCl was 1:3:4. This powder mixture was fired at 650 °C for 10 hours in an argon gas atmosphere to obtain a fired body (block). The fired body was pulverized in a zirconia mortar. The resulting powder was washed with pure water to remove chloride. Next, the fired body was washed with 0.1 M ammonium peroxodisulfate to remove Cu. Next, the washed fired body was subjected to suction filtration, and was vacuum-dried at room temperature in the range of 15 °C to 28 °C. Thus, a powder of a layered material according to Example 1 having a composition represented by Ti_{2.7}Zr_{0.3}C₂Tₛ was obtained, where T represents an atom or functional group constituting the terminal portion of the layered material, and s is any number.

The powder of the layered material according to Example 1, acetylene black powder, and polyvinylidene fluoride were mixed with the addition of N-methyl-2-pyrrolidone to obtain a slurry. This slurry was applied using an applicator onto an aluminum foil having a surface subjected to an etching treatment, and the resulting coating film was vacuum-dried at 60 °C to obtain a MXene-containing film. The laminate of the aluminum foil and the MXene-containing film was cut into a rectangular shape having a short side length of 10 mm and a long side length of 20 mm in plan view to obtain an electrode according to Example 1.

Next, an electrochemical capacitor having a three-electrode cell configuration, serving as an evaluation half-cell, was assembled. This half-cell was configured so that all of the voltage to be applied to the half-cell was applied to the electrode according to Example 1. The assembly and evaluation of the electrochemical capacitor were performed inside a glove box in an argon gas atmosphere to simulate actual manufacturing conditions and use conditions.

As the working electrode of the three-electrode cell, the electrode according to Example 1 was used. As the counter electrode of the three-electrode cell, an activated carbon electrode (AC) was used. Activated carbon and polytetrafluoroethylene serving as a binder were mixed in a mass ratio of activated carbon:binder of 95:5 to obtain an activated-carbon-containing mixture. This activated-carbon-containing mixture was shaped on a Ti mesh, and a Pt wire was attached to the shaped body to obtain an activated carbon electrode. This activated carbon electrode had a capacitance about 10 times or more that of the electrode according to Example 1. As the reference electrode of the three-electrode cell, a Ag/Ag⁺ reference electrode manufactured by EC FRONTIER CO., LTD. was used. As the electrolyte solution of the three-electrode cell, a commercially available 1 M Li—PF6/EC-DMC electrolyte solution was used.

As the cell body of the three-electrode cell, a plate electrode evaluation cell (product code 011951) manufactured by BAS Inc. was used. A rectangular aluminum substrate having a short side length of about 10 mm and a long side length of about 20 mm was disposed on the fluororesin lower block serving as a base. Next, the electrode according to Example 1 was disposed on the aluminum substrate so that the MXene-containing film of the electrode according to Example 1 faced upward. The body block having a cylindrical through hole provided with a fluororesin O-ring was placed on the electrode according to Example 1. The pair of screws located at the left and right ends of the body block were uniformly tightened to sandwich the electrode according to Example 1 between the lower block and the body block. An amount of 1 mL of the electrolyte solution was introduced into the space of the body block. The counter electrode and the reference electrode were attached to the cell cap, which was then fitted into and fixed to the body block. Thus, an electrochemical capacitor serving as an evaluation half-cell was assembled in the form of the plate electrode evaluation cell. After the assembly, the electrochemical capacitor was allowed to stand for 1 hour.

### (Electrochemical Measurement)

Electrochemical measurement was performed using the evaluation half-cell, which was the electrochemical capacitor assembled above. Inside a glove box in an argon gas atmosphere, the working electrode and the reference electrode of the electrochemical capacitor assembled above were connected to external electrodes. An electrochemical measurement apparatus 1287A manufactured by Solartron Analytical and CorrWare software were used, with the scan rate set to 1 mV/s and the scan range set from 0 V (or the open-circuit potential) to −2 V relative to the reference electrode. In this manner, cyclic voltammetry (CV) measurement was performed. From the results of the CV measurement using the evaluation half-cell, the capacitance per unit mass [F/g] of the MXene-containing film of the electrode according to Example 1 was calculated. The result is shown in Table 1A.

### (Quantitative Elemental Analysis)

Quantitative elemental analysis of a sample obtained from the powder of the layered material according to Example 1 was performed by wavelength dispersive X-ray fluorescence analysis (WD-XRF) using a sequential X-ray fluorescence spectrometer ZSX-Primus IV manufactured by Rigaku Corporation. Elements exhibiting a percentage greater than 0.01 mol % and the respective contents are shown in Table 2. In Table 2, the upper row shows the percentages of the elements on a mass basis, and the lower row shows the results of converting the percentages of the elements on a mass basis into the percentages of the elements on an amount-of-substance basis by dividing by the atomic weights [g/mol] of the respective atoms. The nominal composition of the powder of the layered material according to Example 1 was Ti_{2.7}Zr_{0.3}C₂Tₛ, as described above. On the other hand, according to the quantitative elemental analysis, the Ti and Zr composition in the layered material according to Example 1 was represented by Ti_{2.692}Zr_{0.308} based on the results shown in Table 2, and was very close to the nominal composition. The ratio of the mass of O atoms to the total mass of O atoms, Cl atoms, and S atoms, which are considered to be present as the terminal portion of the layered material, was about 87%. This is similar to the condition for the functional groups on the surface in the calculation model of electric double-layer capacitance described below.

### Example 2

A powder of a layered material according to Example 2 was prepared in the same manner as in Example 1 except for the following point. TiC powder, ZrC powder, Ti powder, Al powder, and Si powder were mixed in a zirconia mortar to obtain a powder mixture according to Example 2. These powders were provided by Kojundo Chemical Laboratory Co., Ltd. In the powder mixture according to Example 2, the molar ratio of TiC:ZrC:Ti:Al:Si was 1.7:0.3:1:0.9:0.1. The powder of the layered material according to Example 2 was obtained in the same manner as in Example 1 except that the powder mixture according to Example 2 was used instead of the powder mixture according to Example 1. An electrode according to Example 2 was obtained in the same manner as in Example 1 except that the layered material according to Example 2 was used instead of the layered material according to Example 1. An evaluation half-cell was assembled and electrochemical measurement was performed in the same manner as in Example 1 except that the electrode according to Example 2 was used instead of the electrode according to Example 1. The result is shown in Table 1A.

### Comparative Example 1

A powder of a layered material according to Comparative Example 1 was prepared in the same manner as in Example 1 except for the following points. TiC powder, Ti powder, and Al powder were mixed in a zirconia mortar to obtain a powder mixture according to Comparative Example 1. These powders were provided by Kojundo Chemical Laboratory Co., Ltd. In the powder mixture according to Comparative Example 1, the molar ratio of TiC:Ti:Al was 2:1:1. The powder of the layered material according to Comparative Example 1 was obtained in the same manner as in Example 1 except that the powder mixture according to Comparative Example 1 was used instead of the powder mixture according to Example 1 and that the firing temperature of the powder mixture was adjusted to 1,400 °C. An electrode according to Comparative Example 1 was obtained in the same manner as in Example 1 except that the layered material according to Comparative Example 1 was used instead of the layered material according to Example 1. An evaluation half-cell was assembled and electrochemical measurement was performed in the same manner as in Example 1 except that the electrode according to Comparative Example 1 was used instead of the electrode according to Example 1. The result is shown in Table 1A.

### Example 3

A powder of a layered material according to Example 3 was prepared in the same manner as in Example 1 except for the following point. TiC powder, ZrC powder, Ti powder, and Al powder were mixed in a zirconia mortar to obtain a powder mixture according to Example 3. These powders were provided by Kojundo Chemical Laboratory Co., Ltd. In the powder mixture according to Example 3, the molar ratio of TiC:ZrC:Ti:Al was 1.4:0.6:1:1.1. The powder of the layered material according to Example 3 was obtained in the same manner as in Example 1 except that the powder mixture according to Example 3 was used instead of the powder mixture according to Example 1. In the powder of the layered material according to Example 3, the molar ratio of Zr/(Ti+Zr) was 0.2.

### Reference Example 1

A powder of a precursor according to Reference Example 1 was prepared in the same manner as in Example 1 except for the following points. ZrC powder, Ti powder, and Sn powder were mixed in a zirconia mortar to obtain a powder mixture according to Reference Example 1. In the powder mixture according to Reference Example 1, the molar ratio of ZrC:Ti:Sn was 1:1:1. The powder of the precursor according to Reference Example 1 was obtained in the same manner as in Example 1 except that the powder mixture according to Reference Example 1 was used instead of the powder mixture according to Example 1 and that the firing temperature of the powder mixture was adjusted to 1,200 °C.

### (X-Ray Diffraction)

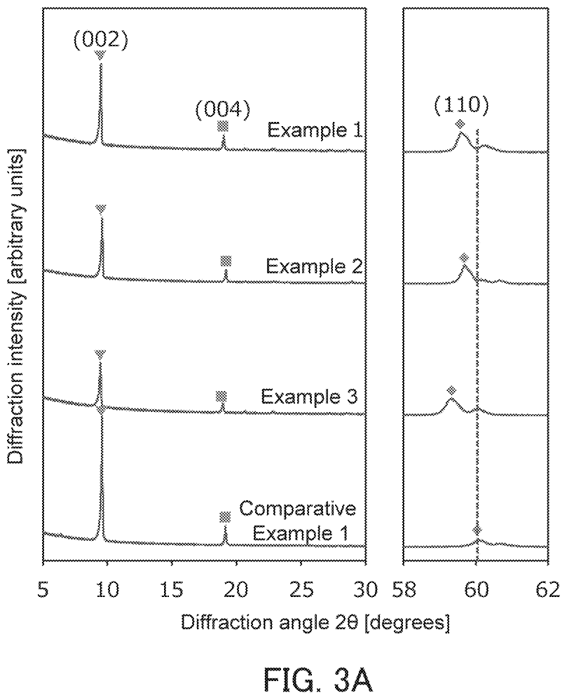

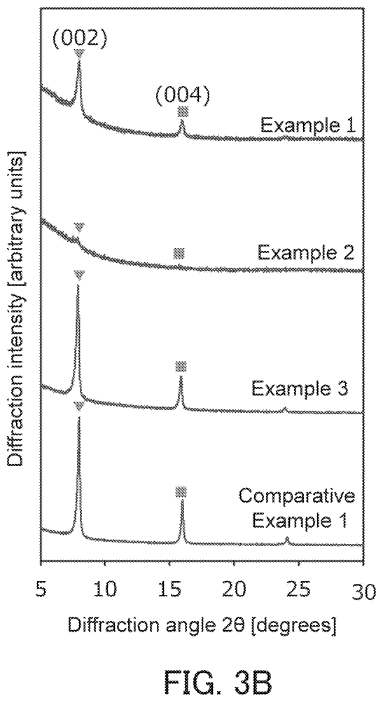

X-ray diffraction (XRD) was performed on the powders of the precursors of the layered materials according to Example 1, Example 2, Example 3, and Comparative Example 1, as well as the powders of those layered materials, using an X-ray diffractometer X'Pert PRO MPD manufactured by PANalytical B.V. The results are shown in FIGS. 3A and 3B.

FIG. 3A is a graph showing the results of the XRD measurements of the precursors of the layered materials according to Example 1, Example 2, Example 3, and Comparative Example 1. FIG. 3B is a graph showing the results of the XRD measurements of the layered materials according to Example 1, Example 2, Example 3, and Comparative Example 1. In FIGS. 3A and 3B, the vertical axis indicates diffraction intensity, and the horizontal axis indicates diffraction angle 2θ. The diffraction intensity on the vertical axis indicates a relative relationship between diffraction intensities within the result of one XRD measurement, and does not indicate a relative relationship between diffraction intensities among the results of a plurality of XRD measurements.

A comparison between FIG. 3A and FIG. 3B suggests that the layered materials according to Example 1, Example 2, Example 3, and Comparative Example 1 contain no precursor and the layered material MXene was generated from the precursor MAX. According to a comparison between Examples 1 to 3 and Comparative Example 1 in FIG. 3A, the diffraction peak corresponding to the (110) plane of the precursor according to each of Examples 1 to 3 is shifted to a lower angle than the diffraction peak corresponding to the (110) plane of the precursor according to Comparative Example 1. This suggests that the size of the crystal lattice of the precursor according to each of Examples 1 to 3 is larger than the size of the crystal lattice of the precursor according to Comparative Example 1. Accordingly, it is considered that, in the crystal lattices of the precursors and the layered materials according to Examples 1 to 3, a portion of Ti is substituted with Zr, which has a larger atomic radius than Ti, as compared with the crystal lattices of the precursor and the layered material according to Comparative Example 1. The diffraction peak corresponding to the (110) plane of the precursor according to Example 3 is shifted to a lower angle than the diffraction peak corresponding to the (110) plane of the precursor according to each of Examples 1 and 2. Accordingly, the amount of Zr substitution in the crystal lattices of the precursor and the layered material according to Example 3 is considered to be larger than the amount of Zr substitution in the crystal lattices of the precursors and the layered materials according to each of Examples 1 and 2.

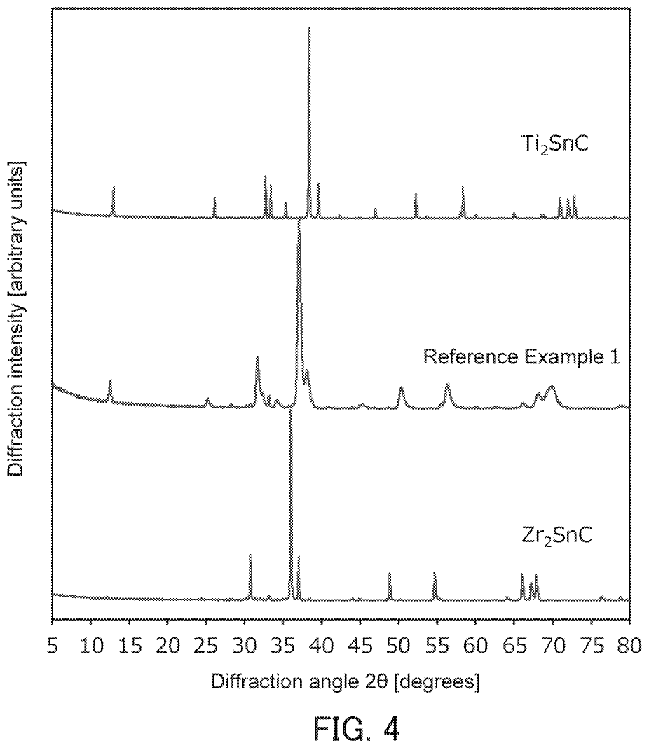

XRD was performed on the powder of the precursor according to Reference Example 1, Ti₂SnC powder, and Zr₂SnC powder using an X-ray diffractometer X'Pert PRO MPD manufactured by PANalytical B.V. The results are shown in FIG. 4. FIG. 4 is a graph showing the results of the XRD measurements of the precursor according to Reference Example 1, Ti₂SnC, and Zr₂SnC. In FIG. 4, the vertical axis indicates diffraction intensity, and the horizontal axis indicates diffraction angle 2θ. The diffraction intensity on the vertical axis indicates a relative relationship between diffraction intensities within the result of one XRD measurement, and does not indicate a relative relationship between diffraction intensities among the results of a plurality of XRD measurements.

As shown in FIG. 4, the position of the XRD diffraction peak of the powder of the precursor according to Reference Example 1 is found at an intermediate position between the position of the XRD diffraction peak of the Ti₂SnC powder and the position of the XRD diffraction peak of the Zr₂SnC powder. Accordingly, the precursor according to Reference Example 1 is considered to be TiZrSnC, which is a solid solution of Ti₂SnC and Zr₂SnC. Therefore, it is considered that, by subjecting the precursor according to Reference Example 1 to an etching treatment in the same manner as for the precursor according to Example 1, a layered material TiZrCTₛ corresponding to TiZrSnC can be generated.

### (Particle Size Distribution Measurement)

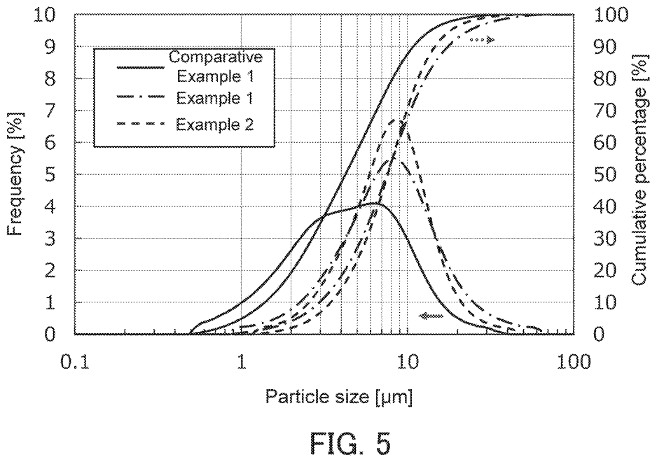

The particle size distributions of the powders of the layered materials according to Example 1, Example 2, and Comparative Example 1 were measured using a laser diffraction particle size analyzer MT3000EXII manufactured by MicrotracBEL Corp. The results are shown in FIG. 5. FIG. 5 is a graph showing the particle size distributions of the layered materials according to Example 1, Example 2, and Comparative Example 1. In FIG. 5, the left vertical axis indicates frequency [%], the right vertical axis indicates cumulative percentage [%], and the horizontal axis indicates particle size.

### (SEM Observation)

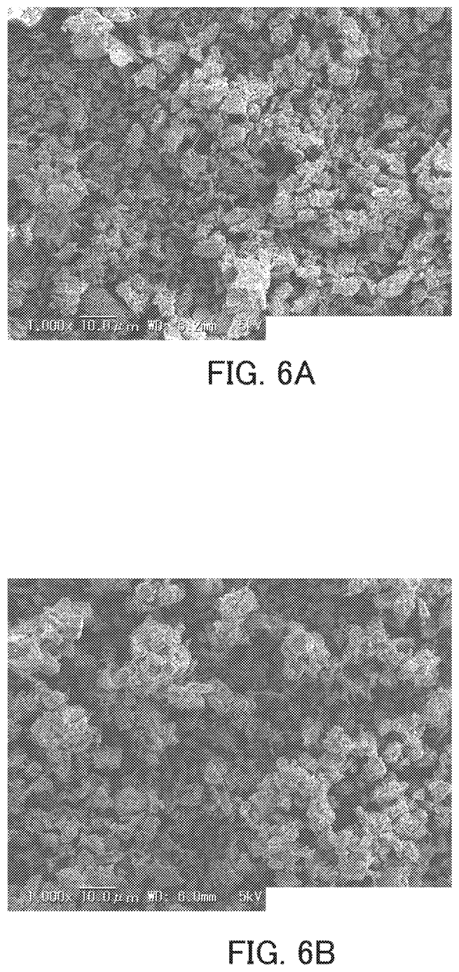

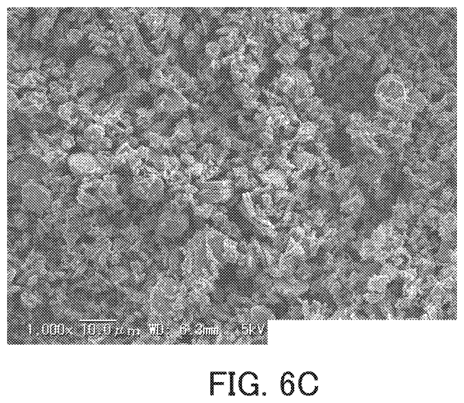

SEM photographs of the layered materials according to Example 1, Example 2, and Comparative Example 1 were obtained using a scanning electron microscope VE-8800 manufactured by KEYENCE CORPORATION. FIG. 6A is the SEM photograph of the layered material according to Example 1, FIG. 6B is the SEM photograph of the layered material according to Example 2, and FIG. 6C is the SEM photograph of the layered material according to Comparative Example 1.

As shown in Tables 1A and 1B, the capacitance per unit mass of the MXene-containing film of the electrode according to each of Examples 1 and 2 is larger than the capacitance per unit mass of the MXene-containing film of the electrode according to Comparative Example 1. According to FIG. 5, the particle size of the powder of the layered material according to each of Examples 1 and 2 is larger than the particle size of the powder of the layered material according to Comparative Example 1. In general, as the particle size of a material decreases, the specific surface area of the material increases, and as the specific surface area of the material increases, the capacitance tends to increase. Nevertheless, referring to Tables 1A and 1B, the capacitance per unit mass of the MXene-containing film of the electrode according to each of Examples 1 and 2, which has a large particle size, is larger than the capacitance per unit mass of the MXene-containing film of the electrode according to Comparative Example 1, which has a small particle size. This is considered to be attributable to the properties of the layered material itself. For example, assume that the specific surface area of the layered material according to each of Examples 1 and 2 is equal to the specific surface area of the layered material according to Comparative Example 1. In this case, it is considered that the difference between the capacitance per unit mass of the MXene-containing film of the electrode according to each of Examples 1 and 2 and the capacitance per unit mass of the MXene-containing film of the electrode according to Comparative Example 1 would be even larger.

### Examples 4 to 16 and Comparative Examples 1 to 16

For MXenes having the compositions shown in Tables 1A and 1B, the electric double-layer capacitances [μF/cm²] of the layered materials according to Examples 4 to 16 and Comparative Examples 1 to 16 were calculated by the ESM-RISM method, which is a type of first-principles calculation. The ESM-RISM method enables rapid prediction of the electronic states of the electrode and the reactant species under an applied electric field by describing the electronic states by density functional theory and describing the distribution of the electrolyte solution by RISM, which is a classical solution theory. The model used for the calculation was prepared as follows: lattice relaxation was performed on the structure of MAX, which is the MXene precursor, by a standard first-principles calculation; then one layer of the MAX structure was extracted to prepare a surface model; O atoms as functional groups were added to the surface; and atomic position relaxation was performed. In the calculation by the ESM-RISM method, in the same manner as in the following literature, electrons were added to the model, a Q-V curve showing the relationship between the surface charge amount Q and the applied voltage V was prepared from the change in Fermi energy relative to the applied charge, and the capacitance was evaluated from the slope of the curve. The charge was varied from 0 to −10 μC/cm². Quantum Espresso code was used for the calculation. The results are shown in Tables 1A and 1B.
Literature: Chemistry of Materials (U.S.) 2022, 34, 5, 2069-2075 https://pubs.acs.org/doi/full/10.1021/acs.chemmater.1c03328

Although the electric double-layer capacitance of the layered material according to each of Examples 1 and 2 was not calculated, it is considered that the electric double-layer capacitance and the capacitance correspond to each other. The capacitance per unit mass of the MXene-containing film of the electrode according to each of Examples 1 and 2 is larger than the capacitance per unit mass of the MXene-containing film of the electrode according to Comparative Example 1. Accordingly, it is considered that the electric double-layer capacitance of the layered material according to each of Examples 1 and 2 is larger than the electric double-layer capacitance of the layered material according to Comparative Example 1.

According to a comparison between the examples and the comparative examples, when the layered material includes two or more elements selected from the group consisting of Ti, Sc, Y, La, Zr, and Hf, the specific capacitance and the electric double-layer capacitance tend to be higher than when the layered material includes only one metal. According to the examples, when the layered material includes two or more elements selected from the group consisting of Ti, Sc, Y, La, Zr, and Hf, the electric double-layer capacitance of the layered material can be 12 μF/cm² or more.

TABLE 1

| | | | | | | | | Calculated value |
|---|---|---|---|---|---|---|---|---|
| | | | | | | | | of electric |
| | | | | | | | Capacitance | double-layer |
| | Layered material composition | M1₍₁₋ₐ₎ₘM2ₐₘCₙ | | | | | per unit mass | capacitance |
| | (precursor composition) | M1 | M2 | m | n | a | [F/g] | [μF/cm²] |
| Example 1 | Ti_{2.7}Zr_{0.3}C₂ (Ti_{2.7}Zr_{0.3}AlC₂) | Ti | Zr | 3 | 2 | 0.1 | 101 | — |
| Example 2 | Ti_{2.7}Zr_{0.3}C₂ (Ti_{2.7}Zr_{0.3}Al_{0.9}Si_{0.1}C₂) | Ti | Zr | 3 | 2 | 0.1 | 94 | — |
| Example 4 | Ti₂ZrC₂ | Ti | Zr | 3 | 2 | 0.33 | — | 12.22 |
| Example 5 | Ti₂HfC₂ | Ti | Hf | 3 | 2 | 0.33 | — | 12.13 |
| Example 6 | Ti₂ScC₂ | Ti | Sc | 3 | 2 | 0.33 | — | 12.07 |
| Example 7 | Ti₂YC₂ | Ti | Y | 3 | 2 | 0.33 | — | 12.59 |
| Example 8 | Ti₂LaC₂ | Ti | La | 3 | 2 | 0.33 | — | 12.43 |
| Example 9 | Zr₂HfC₂ | Zr | Hf | 3 | 2 | 0.33 | — | 12.04 |
| Example 10 | Zr₂YC₂ | Zr | Y | 3 | 2 | 0.33 | — | 13.25 |
| Example 11 | Zr₂LaC₂ | Zr | La | 3 | 2 | 0.33 | — | 13.64 |
| Example 12 | ZrHf₂C₂ | Zr | Hf | 3 | 2 | 0.67 | — | 12.04 |
| Example 13 | ZrSc₂C₂ | Zr | Sc | 3 | 2 | 0.67 | — | 12.24 |
| Example 14 | ZrY₂C₂ | Zr | Y | 3 | 2 | 0.67 | — | 12.35 |
| Example 15 | ZrLa₂C₂ | Zr | La | 3 | 2 | 0.67 | — | 12.06 |
| Example 16 | Zr₂Hf₂C₃ | Zr | Hf | 4 | 3 | 0.5 | — | 12.63 |
| Comp. Ex. 1 | Ti₃C₂ | Ti | — | 3 | 2 | 0 | 62 | 11.65 |
| Comp. Ex. 2 | Cr₃C₂ | Cr | — | 3 | 2 | 0 | — | 11.24 |
| Comp. Ex. 3 | Mo₃C₂ | Mo | — | 3 | 2 | 0 | — | 10.22 |
| Comp. Ex. 4 | Nb₃C₂ | Nb | — | 3 | 2 | 0 | — | 10.43 |
| Comp. Ex. 5 | Ta₃C₂ | Ta | — | 3 | 2 | 0 | — | 10.37 |
| Comp. Ex. 6 | V₃C₂ | V | — | 3 | 2 | 0 | — | 10.82 |
| Comp. Ex. 7 | W₃C₂ | W | — | 3 | 2 | 0 | — | 9.568 |
| Comp. Ex. 8 | Ti₂V₂C₃ | Ti | V | 4 | 3 | 0.5 | — | 10.77 |
| Comp. Ex. 9 | Ti₂Nb₂C₃ | Ti | Nb | 4 | 3 | 0.5 | — | 11.90 |
| Comp. Ex. 10 | Ti₂Mo₂C₃ | Ti | Mo | 4 | 3 | 0.5 | — | 9.983 |
| Comp. Ex. 11 | V₂Nb₂C₃ | V | Nb | 4 | 3 | 0.5 | — | 10.69 |
| Comp. Ex. 12 | V₂Ta₂C₃ | V | Ta | 4 | 3 | 0.5 | — | 10.62 |
| Comp. Ex. 13 | V₂Mo₂C₃ | V | Mo | 4 | 3 | 0.5 | — | 10.98 |
| Comp. Ex. 14 | Nb₂Ta₂C₃ | Nb | Ta | 4 | 3 | 0.5 | — | 10.60 |
| Comp. Ex. 15 | Nb₂Mo₂C₃ | Nb | Mo | 4 | 3 | 0.5 | — | 10.92 |
| Comp. Ex. 16 | Ta₂Mo₂C₃ | Ta | Mo | 4 | 3 | 0.5 | — | 10.88 |

TABLE 2

| Element | O | Ti | C | Zr | Ci | S | Cu | Al | Hf |
|---|---|---|---|---|---|---|---|---|---|
| mass % | 39.8 | 35.7 | 9.89 | 7.80 | 4.34 | 1.66 | 0.34 | 0.22 | 0.18 |
| mol % | 57.4 | 17.2 | 19.0 | 1.97 | 2.82 | 1.19 | 0.12 | 0.19 | 0.02 |

### INDUSTRIAL APPLICABILITY

The layered material of the present disclosure can be used as an electrode active material in an electrode of an electrochemical capacitor, and the electrochemical capacitor is applicable to energy storage in various fields.

What is claimed is:

1. A layered material comprising:
a layer, the layer comprising a body having a composition represented by M1₍₁₋ₐ₎ₘM2ₐₘXₙ and a terminal portion present on a surface of the body, wherein
in the composition,
M1 and M2 are different from each other and each selected from the group consisting of Ti, Sc, Y, La, Zr, and Hf,
X includes at least one selected from the group consisting of a carbon atom and a nitrogen atom,
a is greater than 0 and less than 1,
n is 1 or more and 4 or less, and
m is greater than n and 5 or less.

2. The layered material according to claim 1, wherein
the terminal portion comprises an atom having an electronegativity higher than an electronegativity of each of M1 and M2.

3. The layered material according to claim 1, wherein
the terminal portion comprises at least one selected from the group consisting of a hydroxy group, a hydrogen atom, a halogen atom, a chalcogen atom, an amino group, a phosphorus atom, and an antimony atom.

4. The layered material according to claim 1, wherein
n is 2, and m is 3.

5. The layered material according to claim 1, wherein
X includes a carbon atom.

6. The layered material according to claim 1, wherein
M1 and M2 are atoms different from each other and each selected from the group consisting of Ti, Zr, and Hf.

7. The layered material according to claim 1, wherein
M1 is Ti, and M2 is Zr.

8. The layered material according to claim 7, wherein
a is greater than 0 and 0.33 or less.

9. The layered material according to claim 7, wherein
a is greater than 0 and 0.2 or less.

10. The layered material according to claim 7, wherein
a is greater than 0 and 0.1 or less.

11. The layered material according to claim 1, wherein
M1 is Ti or Zr, and
M2 is Sc, Y, or La.

12. The layered material according to claim 1, wherein
M1 is Ti or Zr,
M2 is Hf, Sc, Y, or La, and
a is greater than 0 and 0.67 or less.

13. The layered material according to claim 12, wherein
a is greater than 0 and 0.5 or less.

14. The layered material according to claim 12, wherein
a is greater than 0 and 0.33 or less.

15. An electrode active material for an electrochemical device, comprising the layered material according to claim 1.

16. An electrochemical device comprising:
a pair of electrodes; and
an electrode active material disposed in contact with at least one of the pair of electrodes, wherein
the electrode active material comprises the layered material according to claim 1.

17. An electrochemical capacitor comprising:
a positive electrode; and
a negative electrode, wherein
the positive electrode and the negative electrode are disposed apart from each other in an electrolyte solution, and
at least one selected from the group consisting of the positive electrode and the negative electrode comprises the layered material according to claim 1 as an electrode active material.

18. The electrochemical capacitor according to claim 17, wherein the negative electrode comprises the layered material as an electrode active material.
